(19) United States
(12) Patent Application Publication
(10) Pub. No.: US 2021/0150236 A1
(43) Pub. Date: May 20, 2021

(54) REMOTE CONTROL METHOD OF THE VEHICLE AND A MIXED REALITY DEVICE AND A VEHICLE

(71) Applicant: LG ELECTRONICS INC., Seoul (KR)

(72) Inventors: Junyoung YU, Seoul (KR); Daegeun HA, Seoul (KR); Soojung JEON, Seoul (KR)

(73) Assignee: LG ELECTRONICS INC., Seoul (KR)

(21) Appl. No.: 16/897,137

(22) Filed: Jun. 9, 2020

(30) Foreign Application Priority Data
Nov. 18, 2019 (KR) 10-2019-0147457

(51) Int. Cl. G06K 9/00; G06K 9/62; B60W 40/08; G06T 19/00

(52) U.S. Cl. CPC G06K 9/00845; G06K 9/00791; B60W 2554/4048; B60W 40/08; G06T 19/006; G06K 9/6267

(57) ABSTRACT

A remote control method of a target vehicle according to an embodiment of the present disclosure includes acquiring a surrounding image around the target vehicle, detecting an object from the surrounding image by a processor, displaying the surrounding image in a mixed reality device and displaying the object as a virtual image or a real image according to a gaze area of a remote driver wearing the mixed reality device or a type of the object, generating a control signal by the processor, based on that a driving module is operated, and transmitting the control signal to the target vehicle. One or more of an autonomous vehicle, a user terminal, and a server of the present invention may be in conjunction with an Artificial Intelligence (AI) module, an Unmanned Aerial Vehicle (UAV), an Augmented Reality (AR) device, a Virtual Reality (VR) device, and a device related to a 5G service, etc.

### CROSS-REFERENCE TO THE RELATED APPLICATIONS

Pursuant to 35 U.S.C. § 119(a), this application claims the benefit of earlier filing date and right of priority to Korean Patent Application No. 10-2019-0147457, filed on Nov. 18, 2019, the contents of which are all hereby incorporated by reference herein in its entirety.

### BACKGROUND OF THE INVENTION

### Field of the Invention

The present disclosure relates to a remote control method of a vehicle and a mixed reality device and a vehicle therefor.

### Related Art

Vehicles may be classified into internal combustion engine vehicles, external combustion engine vehicles, gas turbine vehicles, electric vehicles, etc.

Recently, development of an autonomous vehicle capable of driving on its own with partially or entirely excluding manipulation of a driver has been actively ongoing.

In addition, research into systems and methods for remotely controlling a vehicle is being made. In order to control the vehicle remotely, a driver who is distant from the vehicle must be able to identify the surroundings of the vehicle that is controlled remotely. Furthermore, a method in which the driver who is distant from the vehicle can identify a more accurate and legible image for the surroundings of the vehicle is being sought.

### SUMMARY OF THE INVENTION

The present invention aims to address the aforementioned problem.

Furthermore, the present disclosure provides a remote control method of a vehicle that allows the position of an object around the vehicle to be more accurately displayed and transmitted to a remote driver of the vehicle.

Furthermore, the present disclosure provides a remote control method of a vehicle that allows an object around the vehicle to be more legibly and accurately expressed and transmitted to a remote driver of the vehicle.

In an aspect, a method for remote controlling a target vehicle is provided. The method may include acquiring a surrounding image around the target vehicle, detecting an object from the surrounding image by the processor, displaying the surrounding image in the mixed reality device, and displaying the object as a virtual image ora real image according to a gaze area of a remote driver wearing the mixed reality device or a type of the object, generating a control signal by the processor, based on that the driving module is operated, and transmitting the control signal to the target vehicle.

The acquiring of the surrounding image may generate the image by combining a first image acquired by an indoor camera installed in the target vehicle, and a second image acquired by an outdoor camera installed outside the vehicle.

The method may include verifying a user's gaze area in the virtual environment.

The method may include displaying an image of the gaze area as the real image, based on that the gaze area matches an area of interest associated with driving manipulation equipment of the target vehicle corresponding to the driving module of the target vehicle.

The displaying of the surrounding image may display a background object as the virtual image, based on that the object is the background object corresponding to a fixed object that is immovable.

The displaying of the surrounding image may display an object of interest as the real image, based on that the object is the object of interest requiring a driver's attention.

The object of interest may correspond to a traffic guidance facility.

The object of interest may be an unclassified object whose classification is not verified.

The classifying of the object as the unclassified object may include comparing similarity between the object and a preset moving object or a preset object of interest for guiding driving; and classifying the object as the unclassified object, based on that the similarity is less than a preset threshold value.

The classifying of the object as the unclassified object may include AI learning the object.

The displaying of the surrounding image may further include displaying a control target of the control signal in the driving manipulation equipment of the target vehicle as the real image, on the basis of the generated control signal.

The displaying of the surrounding image may further include verifying gaze information of a passenger in the target vehicle; and displaying an area corresponding to the gaze information of the passenger as the real image.

In another aspect, a mixed reality device is provided. The device may include a communication device receiving the surrounding image from the target vehicle, a head unit supported on a head of a remote driver, a display coupled to the head unit and displaying a virtual image or a real image in a virtual environment, and a processor controlling to display an image by the display. The processor may control to display the object as the virtual image or the real image, according to a type of an object detected in the surrounding image.

The processor may display an image of a user's gaze area as the real image, based on that the user's gaze area matches an area of interest associated with driving manipulation equipment of the target vehicle corresponding to a driving module of the target vehicle.

The processor may control to display a background object as the virtual image, based on that the object is the background object corresponding to a fixed object that is immovable.

The processor may control to display the object as the real image, based on that the object corresponds to a traffic facility.

The processor may control to display the object as the real image, based on that the object is an unclassified object whose classification is not verified.

In a further aspect, a vehicle may transmit a image for a display to a station in real time and drive on the basis of remote control of the station. The vehicle may include a communication device providing the image for the display to the station and receiving a control signal from the station, an object detection device acquiring a surrounding image, and a processor generating the image for the display to display the object as a virtual image or a real image, according to a type of an object detected from the surrounding image.

The object detection device may include an indoor camera installed in the vehicle, and an outdoor camera installed outside the vehicle.

The surrounding image may be generated by combining acquired images in a state where the indoor camera and the outdoor camera are set to have the same photographing angle.

The processor may generate the image for the display to display the object as the real image, based on that the object corresponds to a traffic facility.

The processor may include the image for the display to display the object as the real image, based on that the object is an unclassified object whose classification is not verified.

According to the present disclosure, since a remote driver of a vehicle displays an image around the vehicle in a 3D area on the basis of a mixed reality, the remote driver can more accurately identify the position of an object.

Further, according to the present disclosure, since a background object and objects each having a high frequency of occurrence are displayed as a virtual image, they can be displayed concisely with good legibility. In addition, since objects that need to be carefully checked by a driver are displayed as a real image, a driver can more precisely identify the objects.

### BRIEF DESCRIPTION OF THE DRAWINGS

FIG. 1 shows an exemplary block diagram of a wireless communication system to which methods proposed in the present disclosure is applicable.

FIG. 2 shows an example of a method of transmitting and receiving signals in a wireless communication system.

FIG. 3 shows an example of basic operations between an autonomous vehicle and a 5G network in a 5G communication system.

FIG. 4 shows an example of basic operations between one vehicle and another vehicle using 5G communications.

FIG. 5 is a diagram showing a vehicle according to an embodiment of the present invention.

FIG. 6 is a control block diagram of a vehicle according to an embodiment of the present invention.

FIG. 7 is a control block diagram of an autonomous driving device 100 according to an embodiment of the present invention.

FIG. 8 is a signal flowchart of an autonomous vehicle according to an embodiment of the present invention.

FIG. 9 is a diagram schematically illustrating a remote control system of a vehicle according to an embodiment of the present disclosure.

FIG. 10 is a diagram showing a mixed reality device according to an embodiment of the present disclosure.

FIG. 11 is a diagram showing the configuration of the remote control system of the vehicle according to the embodiment of the present disclosure.

FIG. 12 is a flowchart showing the remote control system of the vehicle according to the embodiment of the present disclosure.

FIG. 13 is a flowchart showing an embodiment in which a mixed reality device of a station displays a real image or a virtual image.

FIG. 14 is a diagram showing an example of a first image.

FIG. 15 is a diagram showing an example of a second image.

FIG. 16 is a diagram showing an example of a gaze area.

FIG. 17 is a flowchart illustrating a method of classifying an object of interest according to an embodiment of the present disclosure.

FIG. 18 is a diagram showing an embodiment in which types of objects in a surrounding image are classified.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the disclosure, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

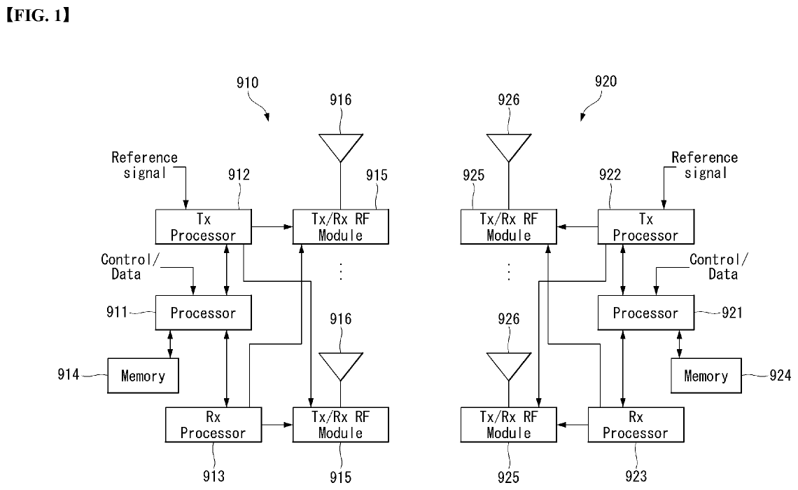

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to Li (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

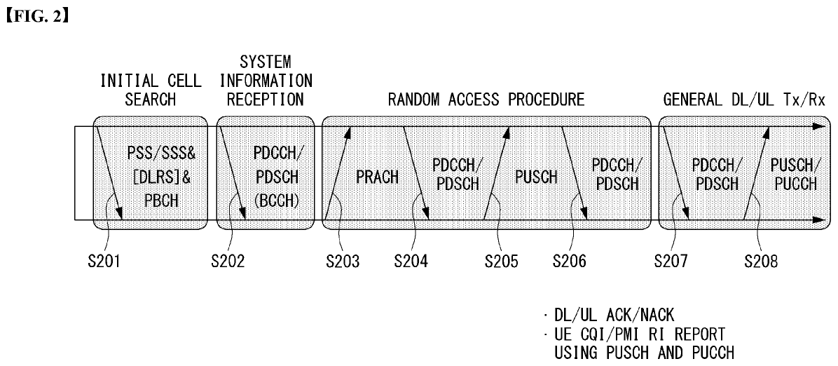

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to verify a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE verifies whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and position lnDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

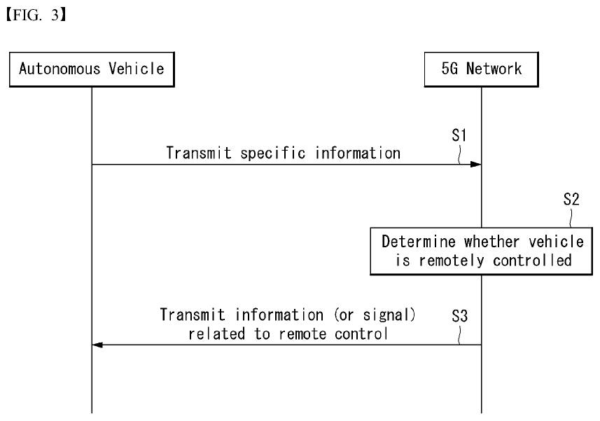

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

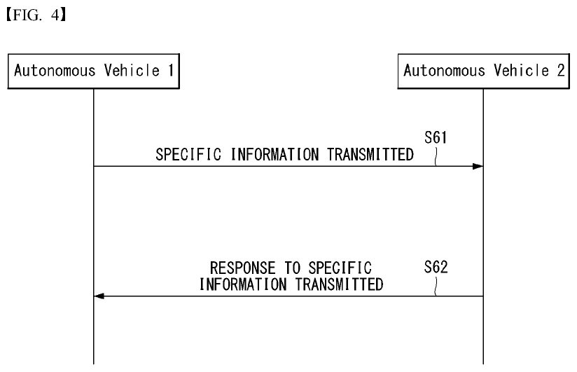

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

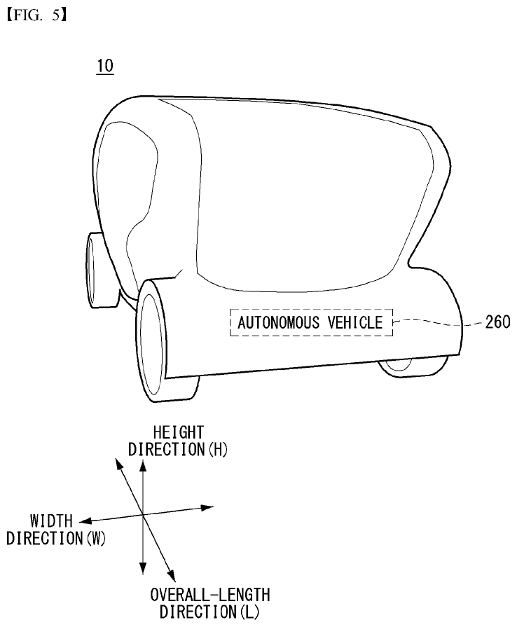

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

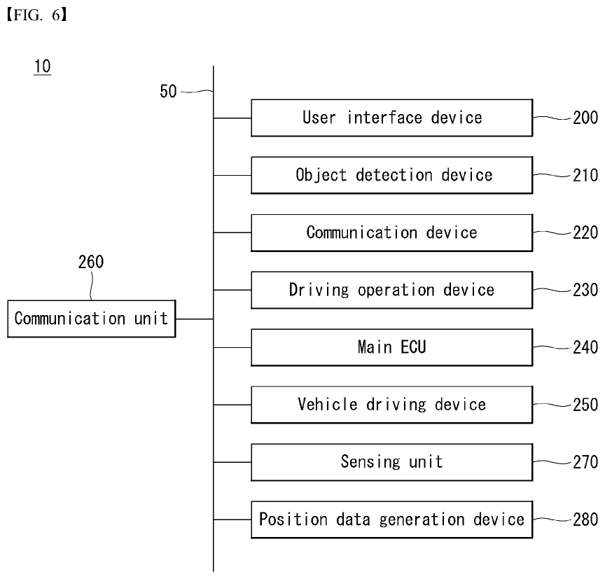

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 ca realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1 Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication disclosures for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

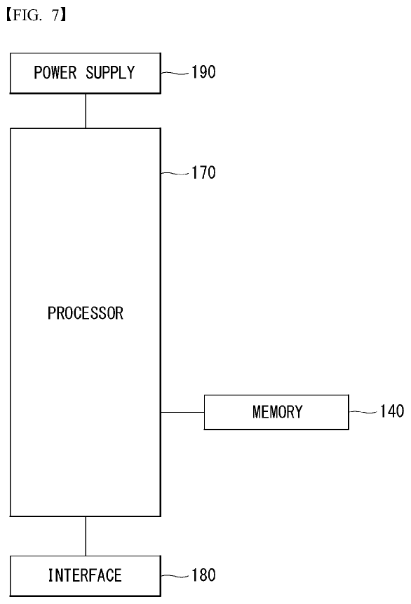

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

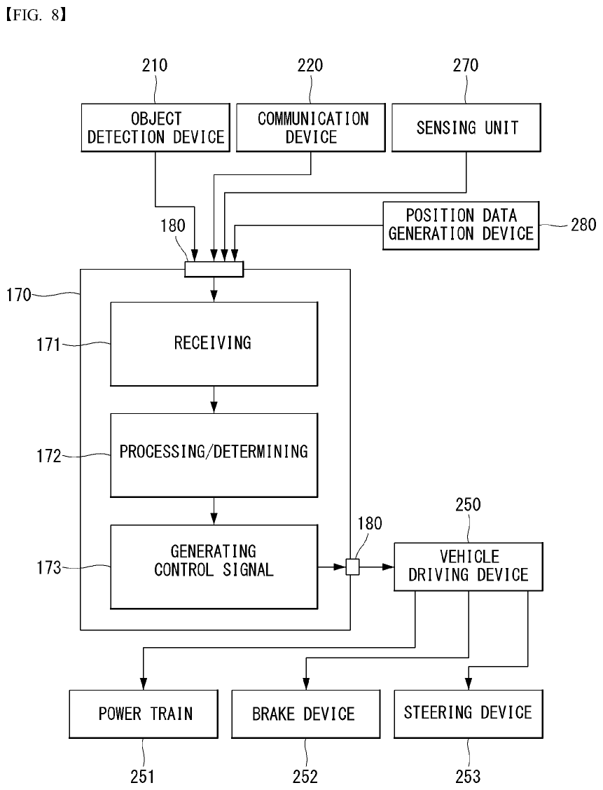

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

The above-mentioned 5G communication technology may be applied in combination with methods proposed in the present disclosure that will be described later, or be supplemented to implement or clarify the technical features of the methods proposed in the present disclosure.

Hereinafter, various embodiments of the present disclosure will be described in detail.

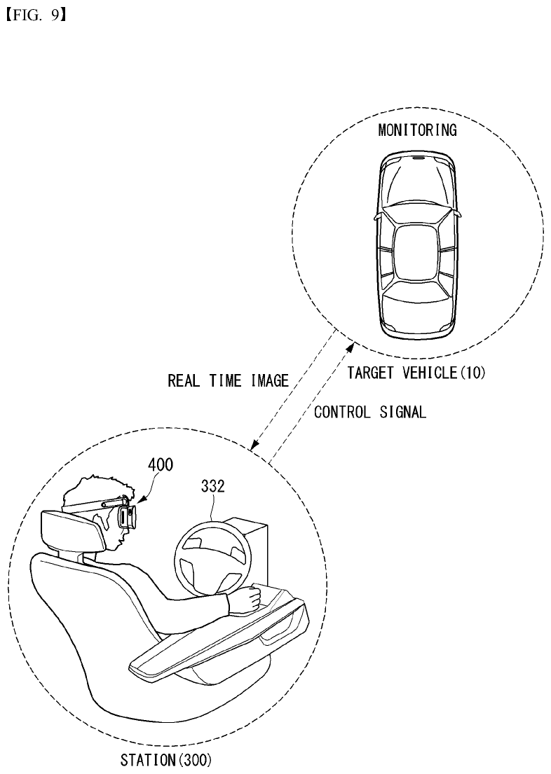

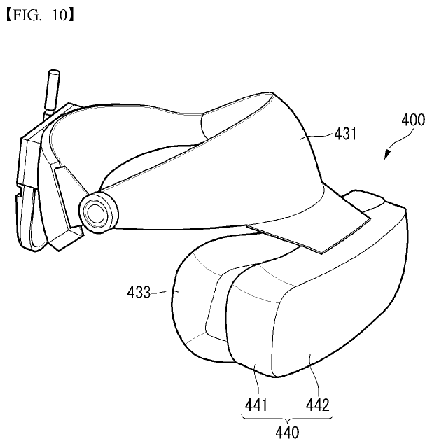

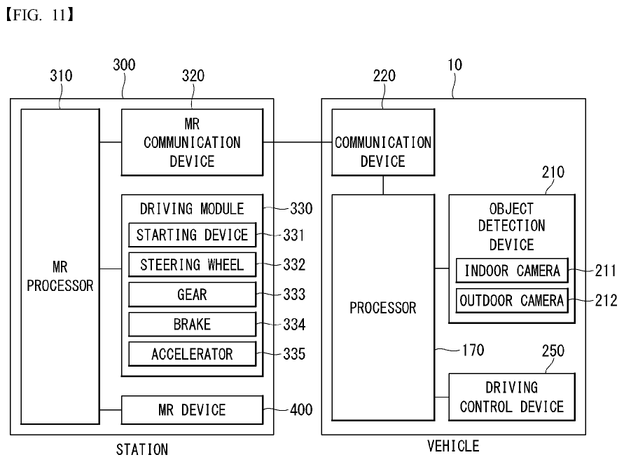

FIG. 9 is a diagram schematically illustrating a remote control system of a vehicle according to an embodiment of the present disclosure. FIG. 10 is a diagram showing a mixed reality device according to an embodiment of the present disclosure. FIG. 11 is a diagram showing the configuration of the remote control system of the vehicle according to the embodiment of the present disclosure.

Referring to FIGS. 9 to 11, the remote control system of the vehicle according to the embodiment of the present disclosure includes a target vehicle 10 that is to be remote controlled, and a station 300 that remote controls the target vehicle 10.

The target vehicle 10 may include an object detection device 210, a driving control device 250, and a communication device 220. The object detection device 210 may include an indoor camera 211 and an outdoor camera 212 that acquire a 2D or 3D image around the vehicle 10. The indoor camera 211 is located at a position corresponding to the eyeline of a driver sitting in a driver's seat, thus acquiring a first image of the target vehicle 10. The first image includes an indoor image of the target vehicle 10 viewed by the driver while being in the vehicle, and an outdoor image identified through a window. In order to acquire the image of various directions in which the driver looks, the indoor camera 211 may include a plurality of cameras. Consequently, the first image may be an image created by combining a plurality of images acquired through the plurality of indoor cameras.

The outdoor camera 212 is disposed outside the vehicle to acquire a second image of the target vehicle 10. The outdoor camera 212 may include a plurality of cameras disposed on the extension line of the driver's eyeline. Consequently, the second image may be an image created by combining a plurality of images acquired through the plurality of indoor cameras.

The processor 170 generates a surrounding image viewed by the driver, by combining the first image acquired by the indoor camera 211 and the second image acquired by the outdoor camera 212.

The communication device 220 of the vehicle 10 transmits a real-time surrounding image generated by the processor 170 to the MR communication device 320 of the station 300. Alternatively, the communication device 220 may transmit the first image and the second image to the station 300.

The driving control device 250 may control the driving and braking of the target vehicle 10, and include a power train 251, a brake device 252, and a steering device 253 shown in FIG. 8.

The station 300 functions to remote control the target vehicle 10, and includes an MR processor 310, an MR communication device 320, a driving module 330, and a mixed reality device 400.

The MR communication device 320 receives the surrounding image from the target vehicle 10, or receives the first image and the second image. Furthermore, the MR communication device 320 may provide a control signal, generated by the processor 170 as the driving module 330 is manipulated, to the target vehicle 10.

The MR processor 310 generates an image for a display generated based on the surrounding image, and provides the image to the display 442 of the mixed reality device 400. The image for the display may be a real image that is directly acquired from the surrounding image, or a virtual image that converts the object of the surrounding image into a preset image.

Furthermore, when the MR processor 310 receives the first image and the second image from the processor 170 of the target vehicle 10, the images may be combined to generate the surrounding image of the target vehicle 10, and the image for the display may be generated based on the surrounding image.

Furthermore, the MR processor 310 is manipulated by the driving module 330 to generate the control signal for controlling the target vehicle 10.

The driving module 330 may be manipulated by a driver of the station 300, and serve to control the driving control device 250 of the target vehicle 10. The driving module 330 may include a starting device 331, a steering wheel 332, a gear 333, a brake 334, and an accelerator 335.

The mixed reality (MR) device 400 provides a virtual environment corresponding to the surrounding environment of the target vehicle 10. As shown in FIG. 10, the mixed reality device 400 may include a head unit 431 and a display unit 440.

The head unit 431 is worn on the head of the human body to support the mixed reality device 400. The head unit 431 may adopt a structure that surrounds a user's head to disperse the weight of the display unit 440 having a heavy weight. The head unit may be provided with a band that is variable in length to match the head sizes of different users.

The display unit 440 is coupled to the head unit 431 to display the virtual image or the real image in front of a user's eyes. The display unit 440 includes a cover part 441 that is coupled to the head unit 431, and the display 442. The cover part 441 has a tub shape to define a space therein, and an opening corresponding to the position of the user's eyeball is formed in a front of the cover part. The display 442 is mounted on a front frame of the cover part 441, and is provided at a position corresponding to the user's both eyes, thus outputting an image.

Although it is shown in the drawing that the head unit 431 and the display unit 440 are separately manufactured and then combined with each other, the display unit 440 may be integrated with the head unit 431. For example, the display 442 may be coupled to an inner side of the head unit 431.

Furthermore, the mixed reality device 400 may include a gyroscope sensor, a motion sensor, or an IR sensor.

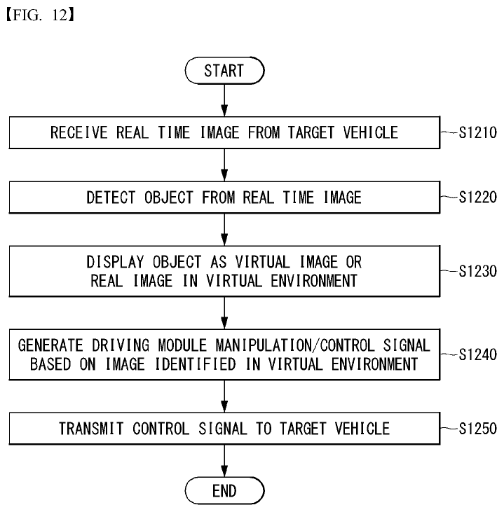

FIG. 12 is a flowchart showing the remote control system of the vehicle according to the embodiment of the present disclosure.

Referring to FIG. 12, at a first step S1210 for remote controlling the target vehicle, the station 300 receives a real-time surrounding image from the target vehicle.

The target vehicle refers to an object that is to be remote controlled. The real-time surrounding image is the surrounding image of the target vehicle. Particularly, this refers to an image viewed from the position of the eyes of the driver who is sitting in the driver's seat of the target vehicle.

At a second step S1220, the station 300 detects an object from the real-time surrounding image. The MR processor 310 of the station 300 may detect the object.

At a third step S1230, the surrounding image is displayed in the virtual environment, and the object is displayed as the virtual image or the real image. In other words, the MR processor 310 provides the virtual image or the real image for the surrounding image to the display 442. For example, the MR processor 310 may control to display not an object requiring an attention during driving but the background object as the virtual image. The virtual image refers to an image that is similar to the real image but is created by simply processing the real image for the purpose of good legibility. For example, similar types of objects may be displayed as the same virtual image. For example, hundreds of types of cars may be displayed as one and the same virtual image.

Furthermore, the MR processor 310 may control to display a traffic facility requiring the attention, such as a traffic light, as the real image. Hereinafter, in this disclosure, the expression “a specific image is displayed” means that the MR processor 310 provides a specific image to the display 442.

At a fourth step S1240, the MR processor 310 generates a control signal, based on that the driving module 330 is manipulated.

At a fifth step S1250, the station 300 transmits the control signal to the target vehicle.

Thus, the target vehicle may be driven on the basis of the received control signal.

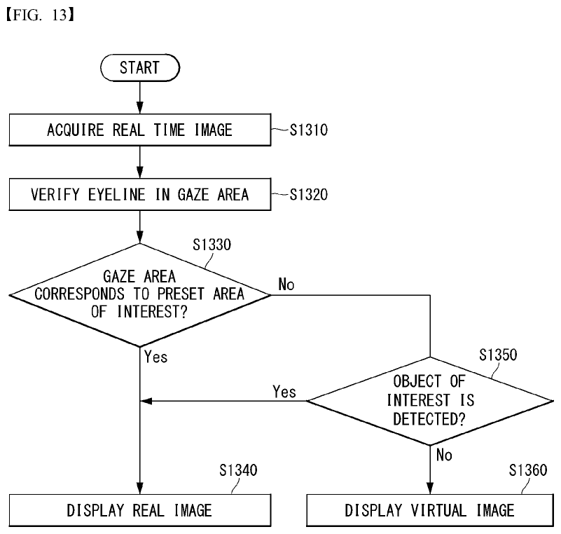

FIG. 13 is a flowchart showing an embodiment in which a mixed reality device of a station displays a real image or a virtual image.

Referring to FIG. 13, at a first step S1310, the station acquires a real-time surrounding image.

As described above, the real-time surrounding image may be generated based on the first imaged acquired by the indoor camera 211 of the target vehicle and the second image acquired by the outdoor camera 212.

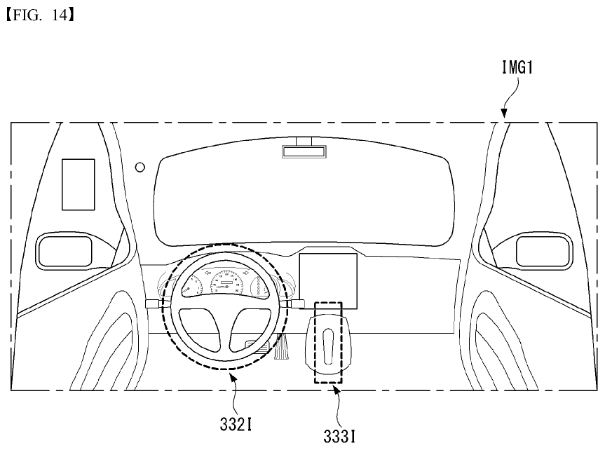

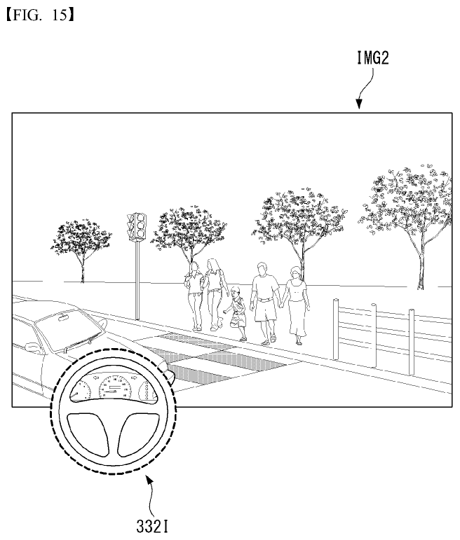

FIG. 14 is a diagram showing an example of the first image, and FIG. 15 is a diagram showing an example of the second image. FIGS. 14 and 15 show the first image IMG1 and the second image IMG2 in the state where a driver's face is directed to a specific direction. The first image IMG1 may include an image acquired via the plurality of indoor cameras 211 having different photographing angles so as to acquire images at various angles to which the driver's face may be directed. Likewise, the second image IMG2 may include an image acquired via the plurality of outdoor cameras 212 having different photographing angles.

The surrounding image is acquired by combining the first image IMG1 and the second image IMG2. For example, by combining the first image IMG1 and the second image IMG2 that are photographed at the same photographing angle as a position to which the driver's face is directed, an image inside the vehicle and an image outside the vehicle may be generated when a driver looks at a specific area. As such, by combining the first image IMG1 and the second image IMG2, a blind spot may be eliminated while increasing the sharpness of the image. If only the indoor camera 211 is used, the sharpness for objects outside the vehicle is reduced, and the blind spot occurs when looking at the outside of the vehicle as in a general vehicle driver. In an embodiment of the present disclosure, since the surrounding image is generated by combining the first image IMG1 and the second image IMG2, it is possible to maintain high sharpness while generating both the vehicle indoor image and the vehicle outdoor image. Furthermore, since the surrounding image includes the second image IMG2 using the outdoor camera 212, it is possible to eliminate the blind spot due to the a pillar of the vehicle 10 or the like.

At a second step S1320, a gaze area is verified. The gaze area refers to an area to which a user's eyes are directed in an image displayed on the display 442 of the mixed reality device 400.

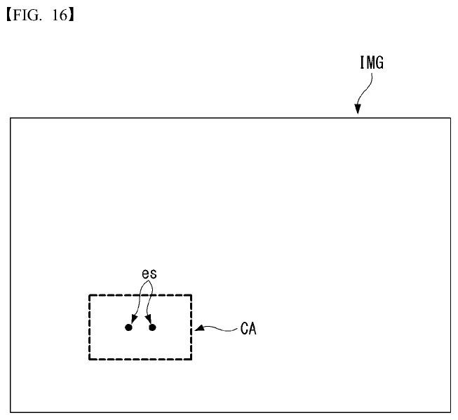

FIG. 16 is a diagram showing an example of a gaze area. As shown in FIG. 16, a focus es of a driver's eye in the image IMG to be displayed on the display 442 is directed to a specific area. The MR processor 310 may verify the focuses es of a driver's both eyes using an eye tracking technique. Moreover, the MR processor 310 may set the focuses es of both eyes as a center, and a certain peripheral range as a gaze area CA.

At a third step S1330 and a fourth step S1340, the MR processor 310 determines whether the gaze area corresponds to a preset area of interest, and displays the real image, based on that the gaze area is the area of interest.

The area of interest is an object that needs to be verified with interest while the remote driver is driving, and may correspond to driving manipulation equipment of the target vehicle 10 corresponding to the driving module 330. For example, in the first image IMG1 as shown in FIG. 14, the area of interest may correspond to the object such as the steering wheel 3321 or the gear 3331 of the target vehicle 10. Since the driving manipulation equipment of the target vehicle 10 is displayed as the real image based on the gaze area of the remote driver of the station 300, the remote driver may remote drive the vehicle while more accurately verifying the driving manipulation equipment.

If the gaze area does not correspond to the area of interest, at a fifth step S1350, it is determined whether the object of interest is detected. Based on that the object of interest is detected at the fifth step S1350, the display 442 displays the real image. If the object of interest is not detected, the display 442 displays the virtual image.

As seen from FIG. 13, when the surrounding image is displayed, the gaze area of the remote driver may be primarily a reference for displaying the virtual image or the real image. Furthermore, according to the type of the object that is secondarily detected, the surrounding image may be displayed as the virtual image or the real image.

By displaying the real image based on that the gaze area of the remote driver is the area of interest, the operating state of the driving control devices of the target vehicle corresponding to the driving module can be more reliably recognized.

Further, the processor 310 may control the display 442 so that the control target of the control signal in the driving module 330 is displayed as the real image so as to cause the remote driver to check the control state of the target vehicle. The skilled remote driver may control the driving module 330 without checking the driving module 330 with the naked eyes. Even in this case, it is necessary to check the operation state of the target vehicle 10 so as to safely drive. Therefore, even if the gaze area of the remote driver does not correspond to the area of interest, the processor 310 may display the control target of the control signal in the driving manipulation equipment of the target vehicle 10 as the real image, based on that the control signal is generated. For example, even if the remote driver does not gaze at the area of interest, when the gear 333 of the driving module 330 is manipulated, the processor 310 may display the gear image 3331 as the real image.

Furthermore, the processor 310 may display the surrounding image on the basis of the gaze information of the remote driver as well as a passenger in the target vehicle 10. For example, the gaze information about the area viewed by the passenger may be acquired using at least any one of the indoor cameras 211 of the target vehicle 10, and then the gaze information may be transmitted to the processor 310. The processor 310 may display the area corresponding to the gaze information in the surrounding image as the real image.

In order to reflect the gaze information of the passenger while the processor 310 displays the image on the display 442, the passenger or the remote driver may change mode setting. For example, in a “basic mode”, the processor 310 may display the surrounding image in consideration of only the gaze area of the remote driver, and may display the area corresponding to the gaze information of the remote driver as the real image in a “passenger gaze information mode”.

The passenger gaze information mode is used to change a destination of the target vehicle 10 or set a specific destination. For example, in order to transmit a more correct place around the destination or an entry path of the destination to the remote driver, the real image of the area viewed by the passenger through the passenger gaze information mode may be transmitted to the remote driver.

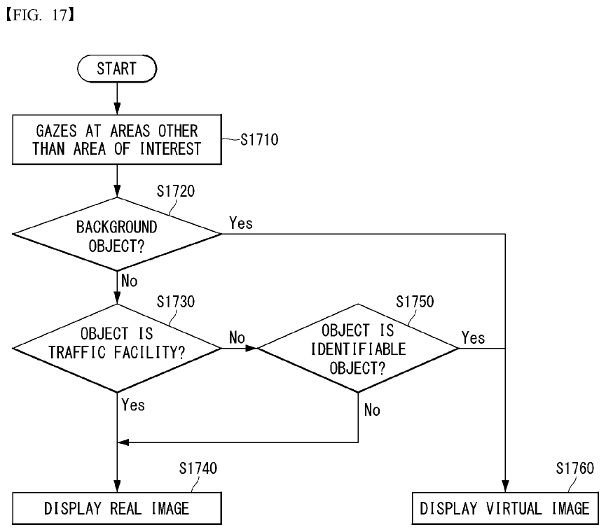

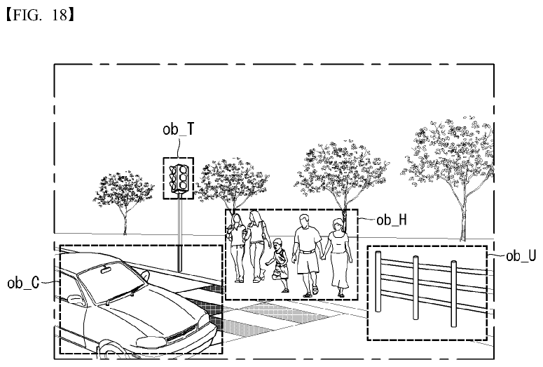

FIG. 17 is a flowchart illustrating a method of classifying an object of interest according to an embodiment of the present disclosure. FIG. 18 is a diagram showing an embodiment in which types of objects in a surrounding image are classified.

Referring to FIG. 17, at a first step S1710, the MR processor 310 determines whether the remote driver gazes at areas other than an area of interest.

At a second step S1720, the MR processor 310 detects the object, and determines whether the detected object is the background object. The background object corresponds to an object that is immovable. The term “immovable object” refers to an object that is commonly determined that its shape and position will not be changed for a long time. For example, the background object includes buildings, roads, roadside threes and the like. The background object may be previously determined on the basis of map data or the like, and may be determined by the MR processor 310 on the basis of the surrounding image acquired in real time.

Based on that the detected object is not the background object, at a third step S1730, the MR processor 310 determines whether the detected object is a traffic facility. The traffic facility refers to a facility for guiding driving, and may include a traffic light, for example.

The MR processor 310 may preset a representative image of a major traffic facility such as a traffic light, and determine that the detected object is the traffic facility, based on that a similarity between the detected object and the representative image is a preset threshold value or more.

Based on that the detected object is the traffic facility at a fourth step S1740, the mixed reality device 400 displays the real image.

Based on that the detected object is not the traffic facility, the MR processor 310 determines whether the detected object is an identifiable object at a fifth step S1750. The identifiable object refers to an object matched with a preset classified object among objects except for the major traffic facility determined at the preceding step. For example, the MR processor 310 sets a car, a two-wheeled car, a pedestrian or the like having a high frequency of detection around a roadway as the classified object and determines whether the detected object corresponds to the classified object. In other words, the MR processor 310 may preset representative images of classified objects, and determine that detected object is the classified object, based on that a similarity between the classified objects and the representative image is a preset threshold value or more.

Based on that the object is the classified object, the mixed reality device 400 displays the virtual image at step S1760. Alternatively, based on that the object is not the classified object, namely, an unclassified object, the mixed reality device 400 displays the real image at step S1740. In other words, the embodiment of the present disclosure sets the unclassified object that is not a traffic guidance facility or preset moving object as the object of interest, and displays the associated object of interest as the real image.

At a sixth step S1760, the mixed reality device 400 displays the virtual image, based on that the object is the background object. Furthermore, the mixed reality device 400 displays the virtual image, based on that the object is not included in the traffic facility and the identified object.

Referring to FIG. 18, the method of displaying the image according to the type of the detected object will be described.

A guard rail ob_U of a road may be classified as the background object and displayed as the virtual image.

A traffic light ob_T may be classified as the major traffic facility and displayed as the real image.

A pedestrian ob_H and an adjacent vehicle ob_C may be classified as the identified object and displayed as the virtual image.

Although the embodiment in which the MR processor 310 is included in the station has been described above, the position of the MR processor 310 is not limited thereto.

For example, the MR processor 310 may be installed in the mixed reality device 400.

Furthermore, the main operation of the MR processor 310 may be performed in the processor 170 of the vehicle 10. That is, the processor 170 of the vehicle 10 may generate an image obtained by mixing the virtual image and the real image, on the basis of the image acquired by the object detection device 210. The processor 170 may generate the surrounding image by combining the first image and the second image. Moreover, the processor 170 may generate the image for the display obtained by mixing the virtual image and the real image by converting the real image into the virtual image according to an object detected from the surrounding image. The mixed reality device 400 of the station 300 may receive the image for the display from the vehicle 10 and then display the image.

The object monitoring unit and the 3D modeling unit according to the above-described embodiment of the present disclosure may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAM,s CD-ROMs, magnetic tapes, floppy disks, optical data storages and others. Furthermore, the computer readable medium may be embodied in the form of a carrier wave (e.g. transmission via the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The above embodiments should be considered in all respects as exemplary and not restrictive. The scope of the present invention should be determined by reasonable interpretation of the appended claims and the present invention covers the modifications and variations of this invention that come within the scope of the appended claims and their equivalents.

What is claimed is:

1. A remote control method of a vehicle for remote controlling a target vehicle in a station comprising a mixed reality device to display a virtual environment, a driving module, and a processor, the method comprising:
acquiring a surrounding image around the target vehicle;
detecting an object from the surrounding image by the processor;
displaying the surrounding image in the mixed reality device, and displaying the object as a virtual image or a real image according to a gaze area of a remote driver wearing the mixed reality device or a type of the object;
generating a control signal by the processor, based on that the driving module is operated; and
transmitting the control signal to the target vehicle.

2. The remote control method of claim 1, wherein the acquiring of the surrounding image generates the image by combining a first image acquired by an indoor camera installed in the target vehicle, and a second image acquired by an outdoor camera installed outside the vehicle.

3. The remote control method of claim 1, wherein the displaying of the surrounding image comprises:
verifying a user's gaze area in the virtual environment; and
displaying an image of the gaze area as the real image, based on that the gaze area matches an area of interest associated with driving manipulation equipment of the target vehicle corresponding to the driving module of the target vehicle.

4. The remote control method of claim 1, wherein the displaying of the surrounding image displays a background object as the virtual image, based on that the object is the background object corresponding to a fixed object that is immovable.

5. The remote control method of claim 1, wherein the displaying of the surrounding image displays an object of interest as the real image, based on that the object is the object of interest requiring a driver's attention.

6. The remote control method of claim 5, wherein the object of interest corresponds to a traffic guidance facility.

7. The remote control method of claim 5, wherein the object of interest is an unclassified object whose classification is not verified.

8. The remote control method of claim 7, wherein classifying of the object as the unclassified object comprises:
comparing similarity between the object and a preset moving object or a preset object of interest for guiding driving; and
classifying the object as the unclassified object, based on that the similarity is less than a preset threshold value.

9. The remote control method of claim 7, wherein the classifying of the object as the unclassified object comprises AI learning the object.

10. The remote control method of claim 1, wherein the displaying of the surrounding image further comprises:
displaying a control target of the control signal in the driving manipulation equipment of the target vehicle as the real image, on the basis of the generated control signal.

11. The remote control method of claim 1, wherein the displaying of the surrounding image further comprises:
verifying gaze information of a passenger in the target vehicle; and
displaying an area corresponding to the gaze information of the passenger as the real image.

12. A mixed reality device for displaying a surrounding image of a target vehicle that is to be controlled remotely, the device comprising:
a communication device receiving the surrounding image from the target vehicle;
a head unit supported on a head of a remote driver;
a display coupled to the head unit, and displaying a virtual image or a real image in a virtual environment; and
a processor controlling to display an image by the display,
wherein the processor controls to display the object as the virtual image or the real image, according to a type of an object detected in the surrounding image.

13. The mixed reality device of claim 12, wherein the processor displays an image of a user's gaze area as the real image, based on that the user's gaze area matches an area of interest associated with driving manipulation equipment of the target vehicle corresponding to a driving module of the target vehicle.

14. The mixed reality device of claim 12, wherein the processor controls to display a background object as the virtual image, based on that the object is the background object corresponding to a fixed object that is immovable.

15. The mixed reality device of claim 12, wherein the processor controls to display the object as the real image, based on that the object corresponds to a traffic facility.

16. The mixed reality device of claim 12, wherein the processor controls to display the object as the real image, based on that the object is an unclassified object whose classification is not verified.

17. A vehicle transmitting an image for a display to a station in real time and driving on the basis of remote control of the station, the vehicle comprising:
a communication device providing the image for the display to the station, and receiving a control signal from the station;
an object detection device acquiring a surrounding image; and
a processor generating the image for the display to display the object as a virtual image or a real image, according to a type of an object detected from the surrounding image.

18. The vehicle of claim 17, wherein the object detection device comprises:
an indoor camera installed in the vehicle; and
an outdoor camera installed outside the vehicle.

19. The vehicle of claim 18, wherein the surrounding image is generated by combining acquired images in a state where the indoor camera and the outdoor camera are set to have the same photographing angle.

20. The vehicle of claim 17, wherein the processor generates the image for the display to display the object as the real image, based on that the object corresponds to a traffic facility.

21. The vehicle of claim 17, wherein the processor generates the image for the display to display the object as the real image, based on that the object is an unclassified object whose classification is not verified.
